(19) United States
(12) Patent Application Publication
(10) Pub. No.: US 2021/0081790 A1
(43) Pub. Date: Mar. 18, 2021

(54) LOCAL INTERPRETABILITY USING AUTOENCODER

(71) Applicant: Zasti Inc., Oakton, VA (US)

(72) Inventors: Ramanathan Krishnan, Oakton, VA (US); John Domenech, Big Pine Key, FL (US); Rajagopal Jagannathan, Chennai (IN); Sharath Makki Shankaranarayana, Chennai (IN)

(21) Appl. No.: 17/018,389

(22) Filed: Sep. 11, 2020

Related U.S. Application Data
(60) Provisional application No. 62/899,383, filed on Sep. 12, 2019.

(51) Int. Cl. G06N 3/08; G06N 3/04; G06N 5/00

(52) U.S. Cl. CPC G06N 3/08; G06N 5/003; G06N 3/0454

(57) ABSTRACT

A facility predicts a weight of two or more independent variables used by a subject model trained to predict outcomes using a first dataset which includes values for the independent variables. The facility creates a second dataset by adding noise to the first dataset and trains an autoencoder to reconstruct the first dataset based on the second dataset. The facility access a subject instance, including an output of the subject model, and generates test data based on the subject instance. The facility obtains output from the subject model for each of the data points in the test data. The facility constructs a training observation from the test data and the subject model output, and determines a weight for each training observation by using the autoencoder. The facility trains a local interpretable model based on the determined weight for each training observation.

### CROSS-REFERENCE TO RELATED APPLICATIONS

This Application claims the benefit of U.S. Provisional Application No. 62/899,383, filed Sep. 12, 2019 and entitled “LOCAL INTERPRETABILITY USING AUTOENCODER-BASED APPROACH,” which is hereby incorporated by reference in its entirety.

In cases where the present application conflicts with a document incorporated by reference, the present application controls.

### BACKGROUND

Machine learning has had tremendous popularity as a method to process and analyze data. Within the area of machine learning, data scientists have increasingly used deep learning methods to process and analyze large amounts of data. Furthermore, data scientists have used these methods to assist in analyzing patient data in order to make predictions about patient outcomes.

### BRIEF DESCRIPTION OF THE DRAWINGS

FIG. 1 is a block diagram showing some of the components typically incorporated in at least some of the computer systems and other devices on which the facility operates.

FIG. 2 is a model diagram visually portraying an autoencoder used by the facility in some embodiments.

FIG. 3 is a flowchart depicting a process performed by the facility in some embodiments to train an autoencoder that is used to train a local interpretable model.

FIG. 4 is a flow diagram depicting a process performed by the facility in some embodiments to generate weights for use in training a local interpretable model.

FIG. 5 depicts a series of graphs which correspond to the coefficients of the linear regression model trained by an embodiment of the facility on the left side and by LIME on the right side.

FIG. 6 is a table depicting the R² scores obtained for test points in the three datasets, which represent the local fidelity of the linear models trained by an embodiment of the facility and LIME.

FIG. 7 depicts a series of graphs which correspond to the local fidelity and local error of the linear regression models trained by an embodiment of the facility and by LIME.

FIG. 8 depicts a series of graphs which correspond to the stability of the linear regression models trained by an embodiment of the facility and by LIME.

### DETAILED DESCRIPTION

The inventors have recognized that deep learning models are opaque and often seen as black boxes, in that it is difficult to understand how the deep learning model has arrived at a specific conclusion. The inventors have determined that it would be beneficial to make these models interpretable, especially in the medical domain. The inventors have recognized that it would be beneficial to better understand the models to ensure they are correct, fair, unbiased, and/or ethical.

Local interpretable model-agnostic explanations (LIME) have been used as a basis for understanding the predictions made by deep learning models, and are described by Taylor, et al., U.S. Patent Publication No. 2018/0101559, which is hereby incorporated by reference in its entirety. LIME seeks to explain an “instance” in which the subject model predicts a dependent variable value based on values for a group of independent variables. For example, a speed may be a dependent variable whose value is predicted by the subject model, and time and distance traveled may be independent variables upon which the subject model bases this prediction. LIME generates single instance-level explanation by artificially generating a dataset in the neighborhood of the instance—groups of independent variable values that are collectively a short distance from the independent variable values of the instance—then training a local linear interpretable model using the instance and the generated dataset. A different local surrogate model is trained to explain each individual prediction.

The process of training a LIME model begins by first selecting the single instance (a “subject instance”) constituting a set of independent variable values and a prediction of a dependent variable value made for them by a “subject” machine learning model. Then, a test dataset is created by perturbing the subject instance and the subject model is used to make predictions for the points of the test dataset. Typically, the perturbed values are obtained by randomly sampling the test dataset by using a Gaussian distribution. The test dataset points are then weighted based on the Euclidean distance from each observation to the subject instance to create a weighted test dataset. Then, an interpretable model is trained on the weighted test dataset and the predictions regarding the instance for explanation are explained by analyzing the coefficients of the interpretable linear model.

The inventors have recognized a variety of disadvantages of using LIME to interpret the operation of a subject model. First, the “fit” of different classes of independent variables is negatively affected as more independent variables, or more “dimensions,” are included in the deep learning model, making LIME less accurate as the model gains complexity. Additionally, as more dimensions are added, it becomes more difficult for a linear model to accurately explain a subject model because it is unable to properly “fit” different classes of independent variables and predictions, and will not be able to properly take into account independent variables and classes which are not clustered together.

In response to recognizing these disadvantages, the inventors have conceived and reduced to practice a software and/or hardware facility for training a local interpretable model to interpret a subject model's basis for prediction using an autoencoder (“the facility”).

In some embodiments, the facility trains a local interpretable model based on a training dataset used for a prediction model. In some embodiments, the facility trains the local interpretable model by using test data instances, each weighted based on the test data's proximity in the “neighborhood” of the test instance obtained from the prediction model. In some embodiments, the facility bases the weights on output from an autoencoder model trained on the training dataset used for the prediction model.

In some embodiments, the facility obtains training data for the autoencoder by sampling a large number of data points from the training data used for the prediction model. In some embodiments, the facility adds “noise” to the training data for the autoencoder by adding data to the training data. In some embodiments, the noise added to the training data is Gaussian noise. In some embodiments, the facility uses masking on the training data for the autoencoder.

In some embodiments, the facility uses the autoencoder to assign a weight to each instance of the test dataset used by the prediction model in order to use the weights as part of training the interpretable model. In some embodiments, the facility obtains a test dataset for the interpretable model based on the output of the prediction model. In some embodiments, the facility adjusts each test data instance by using the autoencoder to assign weights to each test data instance, creating a weighted test dataset. In some embodiments, the facility uses the weighted test dataset to train a local interpretable model. In some embodiments, the local interpretable model is a linear model. In some embodiments, the local interpretable model is one or more decision trees.

In some embodiments, as part of assigning weights to the test dataset, the facility computes the Euclidean distance between each instance of test data and the instance to be explained within the latent vector space of the autoencoder. In some embodiments, each test data point is weighted based on the inverse of the Euclidean distance between each instance of test data and the instance to be explained. In some embodiments, data points with a distance larger than a predetermined threshold are discarded before using the data points for weighting. In some embodiments, the data points are weighted by using an exponential kernel as a function of the distance.

By performing in some or all of the ways described above, the facility is able to create a local interpretable model with higher fidelity and higher stability than a similar model created using LIME. Additionally, the local interpretable model may be used to better interpret the results of the prediction model. Also, the facility improves the functioning of computer or other hardware, such as by reducing the dynamic display area, processing, storage, and/or data transmission resources needed to perform certain task, thereby enabling the task to be performed by less capable, capacious, and/or expensive hardware devices, and/or be performed with lesser latency, and/or preserving more of the conserved resources for use in performing other tasks. For example, by determining weights of data points based on their distance from a subject point at a reduced dimensionality the facility reduces the processing resources needed to compute these distances and train the local interpretable model based on the weighted data points.

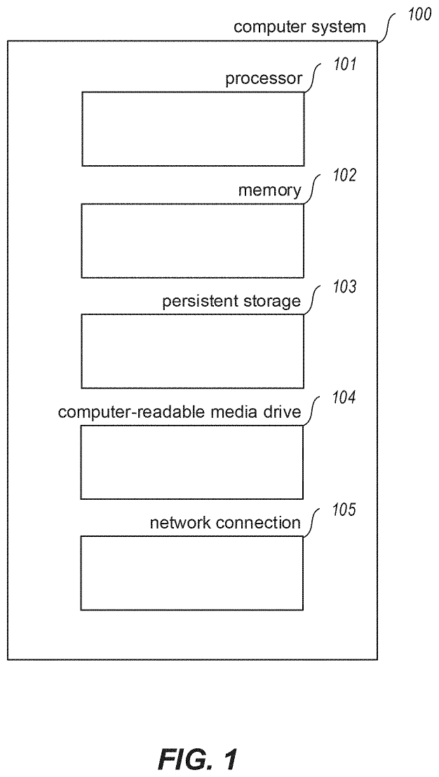

FIG. 1 is a block diagram showing some of the components typically incorporated in at least some of the computer systems and other devices on which the facility operates. In various embodiments, these computer systems and other devices 100 can include server computer systems, cloud computing platforms or virtual machines in other configurations, desktop computer systems, laptop computer systems, netbooks, mobile phones, personal digital assistants, televisions, cameras, automobile computers, electronic media players, etc. In various embodiments, the computer systems and devices include zero or more of each of the following: a processor 101 for executing computer programs and/or training or applying machine learning models, such as a CPU, GPU, TPU, NNP, FPGA, or ASIC; a computer memory 102 for storing programs and data while they are being used, including the facility and associated data, an operating system including a kernel, and device drivers; a persistent storage device 103, such as a hard drive or flash drive for persistently storing programs and data; a computer-readable media drive 104, such as a floppy, CD-ROM, or DVD drive, for reading programs and data stored on a computer-readable medium; and a network connection 105 for connecting the computer system to other computer systems to send and/or receive data, such as via the Internet or another network and its networking hardware, such as switches, routers, repeaters, electrical cables and optical fibers, light emitters and receivers, radio transmitters and receivers, and the like. While computer systems configured as described above are typically used to support the operation of the facility, those skilled in the art will appreciate that the facility may be implemented using devices of various types and configurations, and having various components.

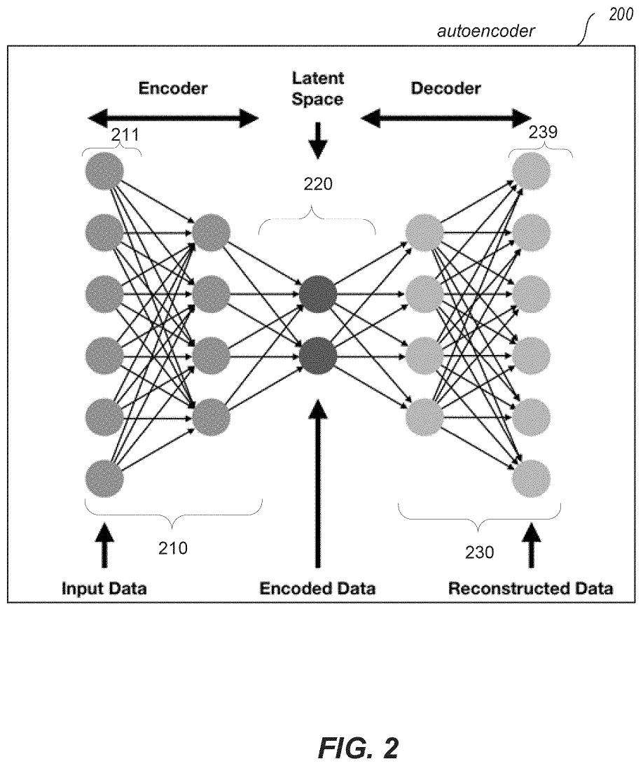

FIG. 2 is a model diagram visually portraying an autoencoder 200 used by the facility in some embodiments. An autoencoder 200 is a neural network which may be used to compress high dimensional data into latent representations by using manifold learning techniques. The autoencoder 200 includes an encoder 210 and a decoder 230. The encoder 210 maps input 211 to a latent vector space 220. In mapping the input 211 to the latent vector space 220, the encoder 210 brings the input 211 into a lower dimensional space, from six dimensions to two dimensions as shown here. The decoder 230 then obtains the data in the latent vector space 220 and maps it into output 239. In mapping the data in the latent vector space 220 to the output 239, the autoencoder 200 brings the data back into the higher dimensional space. For example, an autoencoder may be trained to take in six independent variables, compress them into a vector space for two independent variables, then decompress them back out to a space for six independent variables. Once the facility has trained the autoencoder it can be used as a weighting function by computing the Euclidean distance in the latent vector space 220 instead of in the original higher dimensional space.

In some embodiments, the facility utilizes a “denoising autoencoder.” A denoising autoencoder receives input which has been corrupted by adding a small amount of noise, and then is trained to reconstruct the uncorrupted input. In some embodiments, the facility trains the denoising autoencoder by using the training data used for the prediction model. In some embodiments, the training data is standardized and then corrupted before being used to train the denoising autoencoder. In some embodiments, the facility adds white noise to the training data to corrupt the training data and then trains the autoencoder based on the corrupted training data. In some embodiments, the white noise is white Gaussian noise. In some embodiments, the autoencoder is trained to reconstruct the uncorrupted version of the input using the standard L₂ loss function.

In some embodiments, the autoencoder is a variational autoencoder. In some embodiments, the facility utilizes principal computation analysis instead of the autoencoder. In some embodiments, where the facility utilizes principal computation analyses, the facility represents the test data with matrices and uses matrix multiplication to bring the test data to a lower vector space.

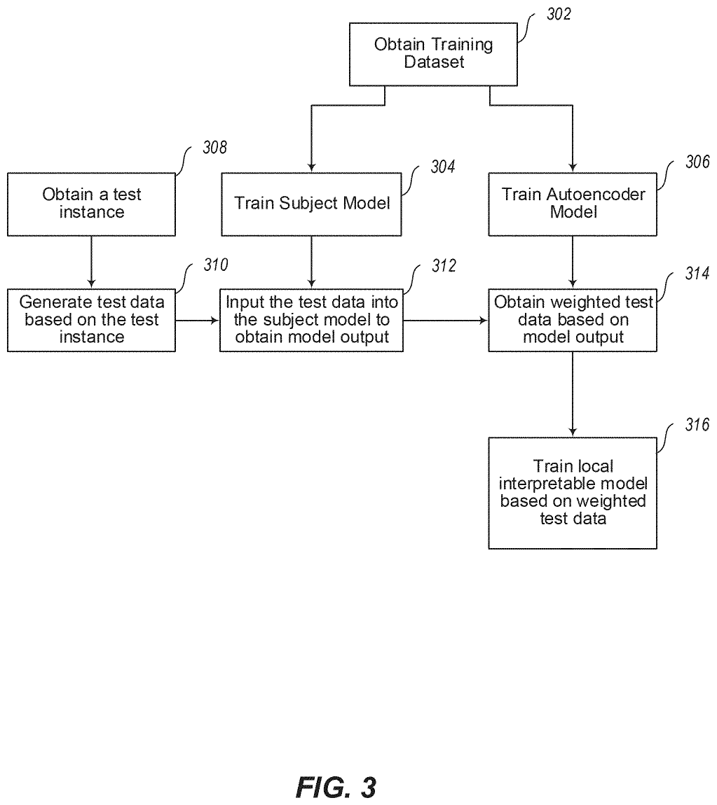

FIG. 3 is a flowchart depicting a process performed by the facility in some embodiments to train an autoencoder that is used to train a local interpretable model. At block 302, the facility obtains a training dataset which includes two or more independent variables. At block 304, the facility trains a subject model to predict outcomes based on the training dataset.

At block 306, the facility trains an autoencoder to reconstruct the training dataset based on a corrupted version of the training dataset. In some embodiments, the facility generates the corrupted version of the training dataset by adding Gaussian white noise to the training data. In some embodiments, the facility utilizes masking to generate the corrupted version of the training data.

At block 308, the facility obtains a test instance from the training dataset. At block 310, the facility generates test data based on the test instance. In some embodiments, the facility generates the test data by perturbation. In some embodiments, the facility uses a Gaussian distribution to generate the data by perturbation. In some embodiments, the facility generates the test data in the neighborhood of the test instance. At block 312, the facility inputs the test data into the subject model to obtain the model output.

At block 314, the facility uses the autoencoder to obtain weighted test data based on the model output and test data. In some embodiments, the facility uses the autoencoder to generate the weights of each data point in the test data based on the model output. In some embodiments, the facility generates the weights by computing the Euclidean distances from the data points in the test data to the test instance in the latent vector space of the autoencoder. In some embodiments, as part of computing the Euclidean distances, the facility discards the data points with a Euclidean distance larger than a predefined threshold. In some embodiments, the facility selects a portion of the test data points for use in determining the weights. In some embodiments, the facility weights the selected data points by using an exponential kernel as a function of distance. In some embodiments, when the facility utilizes principle computation analysis, when the test data is brought to a lower vector space it is plotted on a graph and used to obtain the distances between the test data points and the test instance for weighting.

At block 316, the facility trains a local interpretable model to predict outcomes based on the weighted test data. In some embodiments, the local interpretable model is a linear model. In some embodiments, the local interpretable model is one or more decision trees.

Those skilled in the art will appreciate that the acts shown in FIG. 3 and in each of the flow diagrams discussed below may be altered in a variety of ways. For example, the order of the acts may be rearranged; some acts may be performed in parallel; shown acts may be omitted, or other acts may be included; a shown act may be divided into subacts, or multiple shown acts may be combined into a single act, etc.

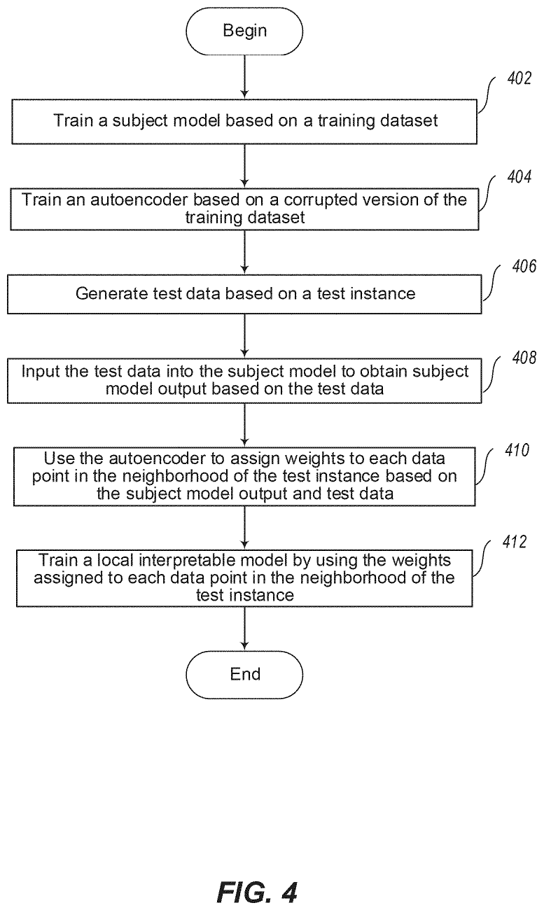

FIG. 4 is a flow diagram depicting a process performed by the facility in some embodiments to generate weights for use in training a local interpretable model. First, at act 402, the facility trains a subject model based on a training dataset. In some embodiments, the subject model is a deep learning model. At act 404, the facility trains an autoencoder to recreate the training dataset based on a corrupted version of the training dataset. In some embodiments, the corrupted version of the training dataset is generated by adding data to the training dataset. In some embodiments, the facility adds data to the training dataset by using Gaussian white noise. In some embodiments, the facility generates the corrupted version of the training dataset by utilizing data masking on the training dataset.

At act 406, the facility generates test data based on a test instance for which an interpretable model should be created. In some embodiments, the facility generates the test data by perturbing the training dataset. In some embodiments, the facility utilizes a Gaussian distribution to perturb the training dataset. In some embodiments, the facility generates data points for the test data before a test instance is selected.

At act 408, the facility inputs the test data into the subject model to obtain the subject model's output based on the test data. At act 410, the facility uses the autoencoder to assign weights to each data point in the test dataset which is in the neighborhood of the test instance based on the model output and test data. In some embodiments, the facility uses the autoencoder to assign the weights based on the Euclidean distance in the latent vector space of the autoencoder from each test data point to the test instance. In some embodiments, the facility uses principle computation analysis to assign the weights for each data point.

At act 412, the facility trains the local interpretable model to predict outcomes based on the weights obtained in act 410 and the test data. In some embodiments, the local interpretable model is a linear model. In some embodiments, the local interpretable model includes one or more decision trees.

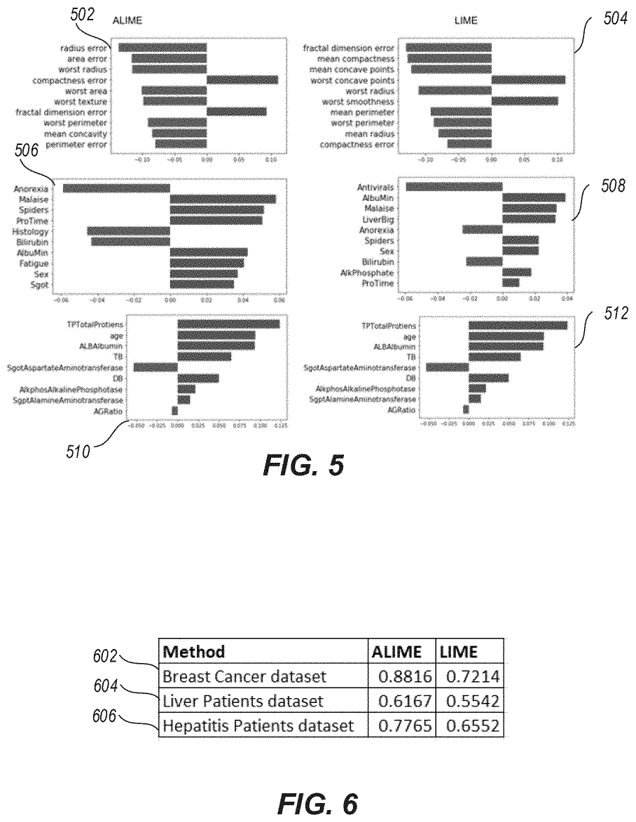

FIGS. 5-8 depict a comparison of the performance of an embodiment of the facility compared to LIME when considering three datasets. The three datasets comprise: a breast cancer dataset which includes 699 patient observations and tracks 11 features used to study breast cancer; a hepatitis patient dataset which includes 155 patient observations and tracks 20 features; and a liver patient dataset which includes 583 patient observations and 11 features used to study liver disease.

Each of the datasets were used to train a feed forward neural network with a single hidden layer having 30 neurons and 2 neurons in the output layer for two classes as the subject model. Each subject model was trained by using a binary cross entropy loss. A 70-30 split was used for training and testing the subject models.

FIG. 5 depicts a series of graphs which correspond to the coefficients of the linear regression model trained by an embodiment of the facility on the left side and by LIME on the right side. Graph 502 is a bar graph depicting the coefficients of the local interpretable model created by an embodiment of the facility and graph 504 is a bar graph depicting the coefficients of the local interpretable model created by LIME based on the breast cancer dataset. The red bars in graphs 502 and 504 indicate negative coefficients, coefficients which indicate a negative correlation between the dependent and independent variables. The green bars in graphs 502 and 504 indicate positive coefficients, coefficients which indicate a positive correlation between the dependent and independent variables. Graphs 506 and 510 each depict the coefficients of the local interpretable model created by an embodiment of the facility based on the hepatitis dataset and liver patients dataset respectively. Graphs 508 and 512 each depict the coefficients of the local interpretable model created by LIME based on the hepatitis dataset and liver patients dataset respectively.

FIG. 6 is a table depicting the R² scores obtained for test points in the three datasets, which represent the local fidelity of the linear models trained by an embodiment of the facility and LIME. The local fidelity is a measure of how accurate the local model is at predicting the same result as the subject model for data in the neighborhood of the test instance. As seen in row 602, the linear model created by an embodiment of the facility had a local fidelity of 0.8816, higher than the local fidelity of the linear model created using lime which had a local fidelity of 0.7214, indicating that the linear model created by an embodiment of the facility is more accurate than the model created by LIME. Additionally, rows 604 and 606 each indicate that the models created by an embodiment of the facility for the liver patient and hepatitis patient datasets are each more accurate than models created by LIME on the same datasets.

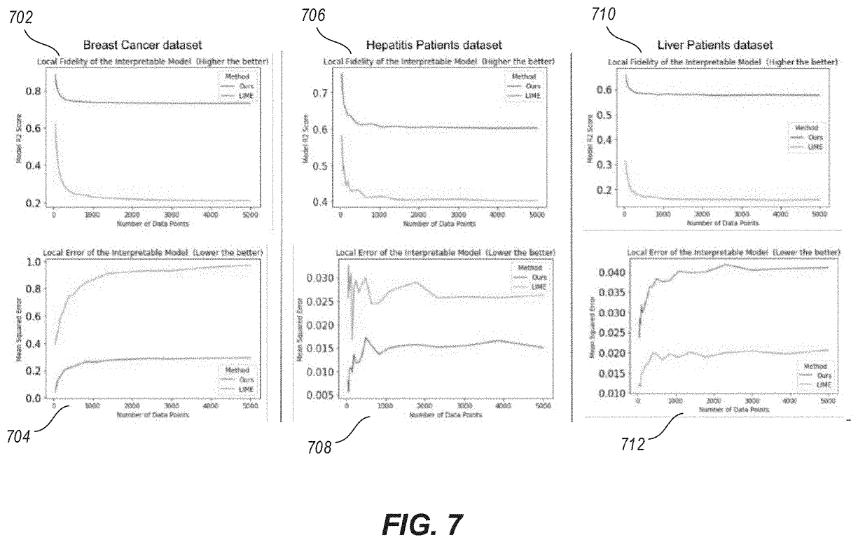

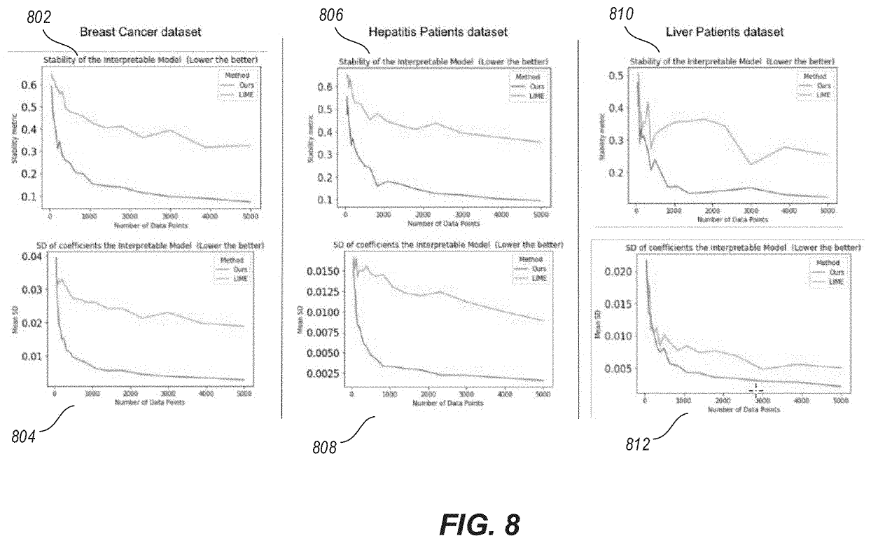

FIG. 7 depicts a series of graphs which correspond to the local fidelity and local error of the linear regression models trained by an embodiment of the facility and by LIME. Graphs 702, 706, and 710 depict the local fidelity of the model trained by an embodiment of a facility and the model trained by LIME for the breast cancer, hepatitis patients, and liver patients datasets respectively. The local fidelity based on the R² score for each of the points in the test datasets generated for each of the respective datasets, and are varied based on a logarithmic scale. As can be seen in graphs 702, 706, and 710 the model created by an embodiment of the facility outperforms the model created using LIME when comparing local fidelity.

Graphs 704, 708, and 712 each depict the local error of the linear regression models created by an embodiment of the facility and LIME. The local error is determined based on the mean squared error of the datasets for each of the data points in the test datasets generated for each of the respective datasets.

FIG. 8 depicts a series of graphs which correspond to the stability of the linear regression models trained by an embodiment of the facility and by LIME. To measure the stability of LIME against an embodiment of the facility, both methods are used to train linear regression models ten times for each dataset. Then, the standard deviation of the coefficients for each of the independent variables of each of the ten trained models is used to determine the stability of the model. Graphs 802, 806, and 810 each depict the stability of the models created by an embodiment of the facility compared with the stability of the models created by LIME. Graphs 804, 808, and 812 each depict the mean standard deviation of the coefficients of the models created embodiment of the facility compared with the mean standard deviation of the models created by LIME. As can be seen from each of graphs 802-812, the linear regression model created by an embodiment of the facility was more stable and had a lower deviation between the coefficients than the linear regression models created by using LIME.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference, in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method in a computing system for predicting a weight of two or more independent variables used by a subject model, the method comprising:
accessing a subject model, the subject model having been trained to predict outcomes using a first dataset, the first dataset including the values for the two or more independent variables;
adding noise to the first dataset to create a second dataset;
training an autoencoder to reconstruct the first dataset based on the second dataset;
accessing a subject instance, the subject instance including an output of the subject model;
generating test data, the test data being generated based on the subject instance, the test data including a plurality of data points;
for each of the data points of the test data:
applying the subject model to the data point to obtain a model output of the value;
constructing a training observation comprising the data point and the obtained model output value; and
determining a weight for the constructed training observation using the trained autoencoder; and
using the constructed training observations and their weights to train a local interpretable model.

2. The method of claim 1, further comprising:
for each of the data points of the test data:
computing the Euclidean distance between the training observation and the subject instance within the latent vector space of the trained autoencoder; and
determining the weight for the constructed training observation based on the computed Euclidean distance between the training observation and the subject instance.

3. The method of claim 1, further comprising:
accessing the coefficients of the local interpretable model; and
identifying the influence of each of the independent variables on the subject instance for the subject model based on the coefficients of the local interpretable model.

4. The method of claim 1, wherein the local interpretable model is a linear regression model.

5. The method of claim 1, wherein the local interpretable model is one or more decision trees.

6. One or more memories collectively storing a local interpretable model training data structure, the data structure comprising:
information indicating a first dataset, the first dataset including the values for two or more independent variables;
information indicating a subject model, the subject model having been trained to predict outcomes using the first dataset;
information indicating a second dataset, the second dataset having been created by adding noise to the first dataset;
information indicating an autoencoder, the autoencoder having been trained to reconstruct the first dataset from the second dataset;
information indicating a subject instance, the subject instance including an output of the subject model;
information indicating test data, the test data being generated based on the subject instance, the test data including a plurality of data points; and
information indicating subject model output for each of the data points of the test data, the subject model output having been obtained by applying the subject model to each of the data points of the test data,
such that, the subject model output is usable to create training observations, each training observation comprising the data point and the subject model output for the data point,
and such that the autoencoder is usable to create a weighted data point based on the training observations and train a linear interpretable model based on the training observations.

7. The one or more memories of claim 6, the data structure further comprising:
a plurality of Euclidean distances for each data point, the Euclidean distance being determined by measuring the distance between the training observation and the subject instance within the latent vector space of the trained autoencoder,
such that the plurality of Euclidean distances are usable to create the weighted data point based on the training observations.

8. The one or more memories of claim 6, the data structure further comprising:
a coefficient of each of the independent variables of the local interpretable model,
such that the coefficient of each of the independent variables of the local interpretable model are usable to identify the influence of each of the independent variables on the subject instance.

9. The one or more memories of claim 6, wherein the local interpretable model is a linear regression model.

10. The one or more memories of claim 6, wherein the local interpretable model is one or more decision trees.

11. A system for predicting a weight of two or more independent variables used by a subject model, the system comprising:
a computing device having access to a subject model, the computing device additionally having access to a first dataset, the subject model having been trained to predict outcomes using the first dataset, the first dataset including the values for two or more independent variables; and
the computing device being configured to:
add noise to the first dataset to create a second dataset;
train an autoencoder to reconstruct the first dataset based on the second dataset;
access a subject instance, the subject instance including an output of the subject model;
generate test data, the test data being generated based on the subject instance, the test data including a plurality of data points;
for each of the data points of the test data:
apply the subject model to the data point to obtain a model output of the value;
construct a training observation comprising the data point and the obtained model output value; and
determine a weight for the constructed training observation using the trained autoencoder; and
use the constructed training observations and their weights to train a local interpretable model.

12. The system of claim 11, wherein the computing device is further configured to:
for each of the data points of the test data:
compute the Euclidean distance between the training observation and the subject instance within the latent vector space of the trained autoencoder; and
determine the weight for the constructed training observation based on the computed Euclidean distance between the training observation and the subject instance.

13. The system of claim 11, wherein the computing device is further configured to:
access the coefficients of the local interpretable model; and
identify the influence of each of the independent variables on the subject instance for the subject model based on the coefficients of the local interpretable model.

14. The system of claim 11, wherein the local interpretable model is a linear regression model.

15. The system of claim 11, wherein the local interpretable model is one or more decision trees.
